(19) United States
(12) Patent Application Publication
(10) Pub. No.: US 2007/0283090 A1
(43) Pub. Date: Dec. 6, 2007

(54) Storage system and volume management method for the same

(76) Inventors: Tomoyuki Kaji, Kamakura (JP); Mikihiko Tokunaga, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/493,620

(22) Filed: Jul. 27, 2006

(30) Foreign Application Priority Data
Jun. 6, 2006 (JP) 2006-157867

(51) Int. Cl. G06F 12/16

(52) U.S. Cl. 711/114

(57) ABSTRACT

A cluster-structured storage system where the access performance from a host system to a volume in an alternative-type storage subsystem is not degraded during failover, and a method for managing volume in the storage system. In this storage system, storage areas forming a primary storage subsystem and storage areas forming a standby storage subsystem are both hierarchized and correspondence relationships are established between the hierarchical levels. A copy destination volume is located on a hierarchical level associated with the hierarchical level of a copy source volume.

### CROSS-REFERENCES TO RELATED APPLICATIONS

This application relates to and claims priority from Japanese Patent Application No. 2006-157867, filed on Jun. 6, 2006 the entire disclosure of which is incorporated herein by reference.

### BACKGROUND

1. Field of the Invention

The present invention relates to a storage system and in particular a storage system having a primary storage subsystem and a standby storage subsystem, where when trouble occurs in the primary storage subsystem, the standby storage subsystem can take over the processing in the primary storage subsystem. This invention also relates to volume management in the storage system.

2. Description of Related Art

In storage systems considering non-interrupted performance (e.g., disaster recovery), data in one storage subsystem has to be copied to another storage subsystem. Remote copy using the volume replication function of the storage systems is known as a technique to achieve this.

In industries such as the banking industry, where great amount of data has to be processed to offer services, storage systems having multiple HDDs are used for data processing and maintenance. Because cluster structures are adopted for data processing units and data storing units in these storage subsystems, high data stability is secured in spite of the occurrence of various kinds of trouble.

In storage systems using remote copy techniques, when trouble occurs in a primary storage subsystem, a host accesses a copy destination volume in a standby storage subsystem so that it can continue the processing in progress having been carried out by accessing a copy source volume in the primary storage subsystem, using the standby storage subsystem. The technique of having a substitute storage subsystem take over the processing of a primary storage subsystem when it has a problem is called ‘failover.’

Japanese Patent Laid-Open Publication No. 2004-246852 discloses a storage system of the foregoing type. This storage system is a failover-type cluster system and, as shown in FIG. 4 attached to the publication, in order to prevent degradation of the performance of the entire system after failover, when writing data, which has been written in a volume (copy source volume) 2210 in a parity group 3400 in a storage apparatus 2200, in a volume (copy destination volume) 2310 in a parity group 3300 in a storage apparatus 2300 using a remote copy function, whether or not both or either of the following two conditions regarding the pair of the volumes is met is judged during the copy: condition (1)—the post-failover performance of the copy destination volume is higher than the pre-failover performance of the copy source volume; and condition (2)—during the copy, the performance of the copy destination volume is higher than that of the copy source volume; and, if none of the conditions is met, the configuration of the storage apparatus having the copy destination volume defined therefor is changed so that both or either of the above conditions is satisfied.

The Applicants explain the object of this invention with reference to FIG. 1 attached to this application. FIG. 1 shows a remote copy system composed of a primary node 10 and standby node 20. Each node is composed of a storage subsystem and a host system (host) that accesses the storage subsystem.

In the storage system shown in FIG. 1, when a problem occurs in the primary host or primary storage subsystem, the standby node takes over the services the primary host and primary storage subsystem had been providing to users. The primary storage subsystem is indicated by the reference numeral 1500 and the standby storage subsystem is indicated by 1600. Each storage subsystem includes array groups composed of multiple memory devices defined by RAID, and each array group has one or more volumes inside. One of the array groups in the primary storage subsystem is indicated by the reference numeral 1700 and one of the array groups in the standby storage subsystem is indicated by 1800. Volumes are storage areas formed in array groups and accessed by the hosts. In other words, these volumes are used by the hosts that are connected to the storage subsystems via fibre cables.

A host 1000 accesses via a Fibre Channel switch 1300 a volume 1710 in the primary storage subsystem 1500. This volume (copy source volume) 1710 is remote-copied via another Fibre Channel switch 1310 to a volume (copy destination volume) 1810 in the standby storage subsystem 1600. A host 1100 accesses via another Fibre Channel switch 1320 to the volume 1810 in the standby storage subsystem 1600.

In FIG. 1, the volume 1710 exists in the array group 1700. Accordingly, the access performance from the host 1000 to the volume 1710 depends on the utilization rate of the array group 1700. Likewise, the volume 1810 exists in the array group 1800. Accordingly, the access performance from the host 1100 to the volume 1810 depends on the utilization rate of the array group 1800. When trouble occurs in the primary node, the standby node succeeds the primary node in the ongoing operations.

In addition to the volume 1810, a volume 1820 exists in the array group 1800 and another host 1200 accesses this volume 1820 via a Fibre Channel switch 1320. Accordingly, the utilization rate of the array group 1800 is higher than that of the array group 1700. If it is assumed that the utilization rate of the array group 1700 is 25% and that of the array group 1800 is 60%, when the standby node succeeds the primary node in the ongoing operations, the access performance degrades. This is because the utilization rate of the array group 1800 is higher than that of the array group 1700, the access performance from the host to a volume in the array group 1800 degrades. As explained, in a storage system where storage subsystems are each composed of clusters, there is a problem in that the access performance from hosts degrades when failover is performed.

In light of these facts, this invention aims to provide: a storage system which is composed of clusters and prevents degradation of the access performance from a host to a volume in a substitute storage subsystem when failover is performed; and a volume management method for the storage system.

### SUMMARY

This invention is a storage system that guarantees that a copy destination volume in a standby storage subsystem has volume performance of the same level as that of a copy source volume in a primary storage subsystem.

According to one aspect of this invention, storage resources in a first storage subsystem are configured to form a hierarchical structure; storage resources in a second storage subsystem are also configured to form a hierarchical structure; the respective hierarchical levels in the first storage subsystem and the second storage subsystem are associated with each other; a volume in the second storage subsystem is located on a hierarchical level corresponding to the hierarchical level of a corresponding volume in the first storage subsystem based on the correspondence relationships; and, when performing failover, if a volume in the second storage subsystem exists on a hierarchical level not corresponding to that in the first storage subsystem, this volume is migrated from the non-corresponding hierarchical level to the corresponding hierarchical level.

If a hierarchical level is defined based on the access performance from a host system to that hierarchical level, a volume to be located on that hierarchical level has the performance defined for that hierarchical level. Therefore, if the hierarchical level a volume in the second storage subsystem should belong to is determined according to the hierarchical level the corresponding volume in the first storage subsystem belongs to, even when the destination of access from the host is switched from the volume in the first storage subsystem to the corresponding volume in the second storage subsystem, the second storage subsystem can provide data in that volume to the host system without degrading the access performance from the host system thereto. Because the correspondence relationships between the hierarchical levels are already set and the performance of the respective levels are already defined, if a volume in the second storage subsystem is migrated from one hierarchical level to another, its performance can be maintained. The foregoing publication does not describe or imply that, in a plurality of storage subsystems, storage areas are arranged in hierarchies and correspondence relationships are established between the hierarchical levels.

### BRIEF DESCRIPTION OF THE DRAWINGS

FIG. 1 is a hardware block diagram showing a storage system related to this invention.

FIG. 2 is a hardware block diagram showing a storage system according to one embodiment of this invention.

FIG. 3(1) is a block diagram showing the relationships between memory devices constituting an array group and volumes formed by these memory devices.

FIG. 3(2) is a block diagram showing the relationships between hierarchical levels and array groups.

FIG. 4 is a table showing factors/content defining hierarchical levels.

FIG. 5 shows an example of a definition of the hierarchical structure in a primary storage subsystem and that in a standby storage subsystem.

FIG. 6 is a functional block diagram showing an operation to migrate a copy destination volume to a corresponding virtual volume phase when the hierarchical level of a copy source volume does not correspond to the hierarchical level of the copy destination volume.

FIG. 7 is a control table defining correspondence relationships between the hierarchical levels in the primary storage subsystem and those in the standby storage subsystem.

FIG. 8 is a table showing an example of utilization rates of array groups constituting the hierarchical levels.

FIG. 9 is a functional block diagram showing a management system.

FIG. 10 is a table storing performance information for the storage subsystems.

FIG. 11 is an example of a remote copy management table.

FIG. 12 is an example of a volume management table.

FIG. 13 is an example of an array group management table.

FIG. 14 is an example of a hierarchical level correspondence table.

FIG. 15 is a hardware block diagram showing another embodiment of the storage system.

FIG. 16 is a block diagram explaining migration of a volume for failover in the storage system in FIG. 15.

FIG. 17 is an example of a flowchart explaining operations performed based on a performance information acquisition program.

FIG. 18 is an example of a flowchart explaining operations performed based on a configuration confirmation program.

FIG. 19 is another example of a flowchart explaining operations performed based on a configuration change program.

FIG. 20 is an example of a flowchart explaining migration of a copy destination volume over hierarchical levels.

FIG. 21 is a block diagram showing an embodiment where the management system is provided in a controller in the storage system.

### DETAILED DESCRIPTION OF PREFERRED EMBODIMENTS

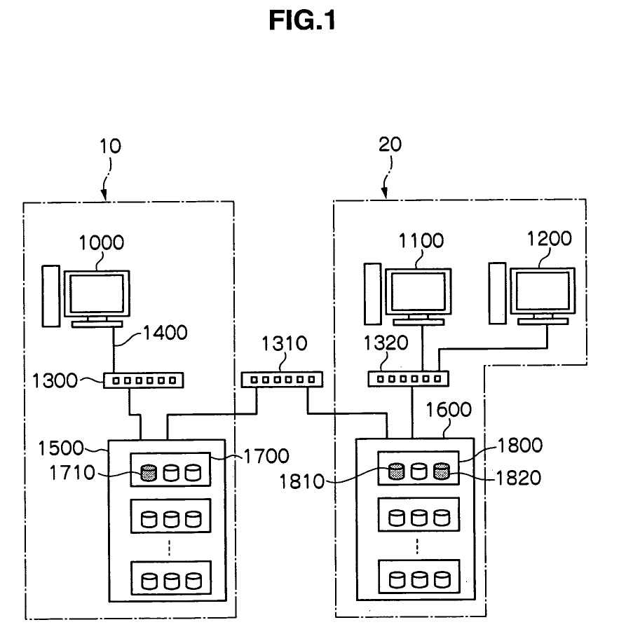

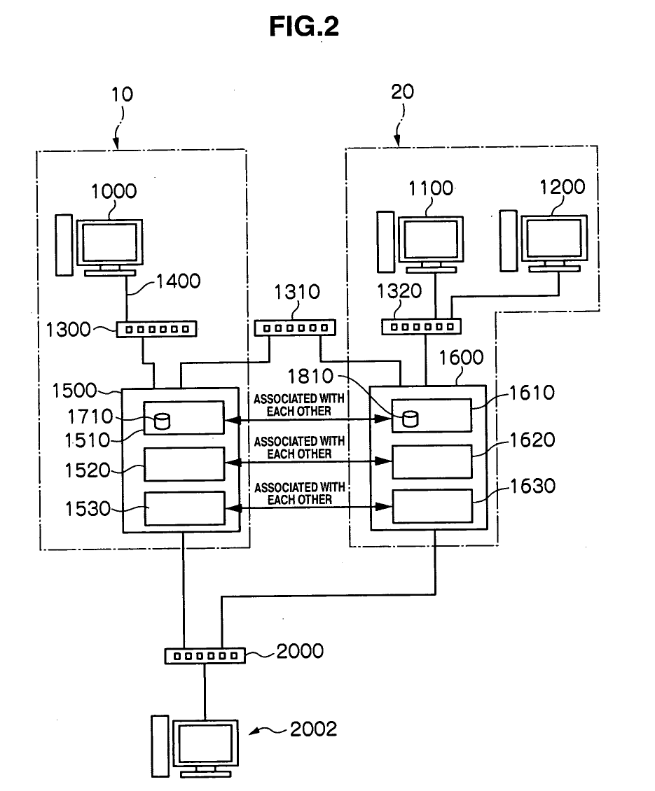

Embodiments of this invention are explained below. FIG. 2 is a block diagram showing a storage system having a primary storage subsystem and a standby storage subsystem. This storage system is different from the storage system in FIG. 1 in that the volumes in the primary and standby storage subsystems are managed by being divided into hierarchical levels and the hierarchical levels in the primary storage subsystem are associated with the hierarchical levels in the standby storage subsystem.

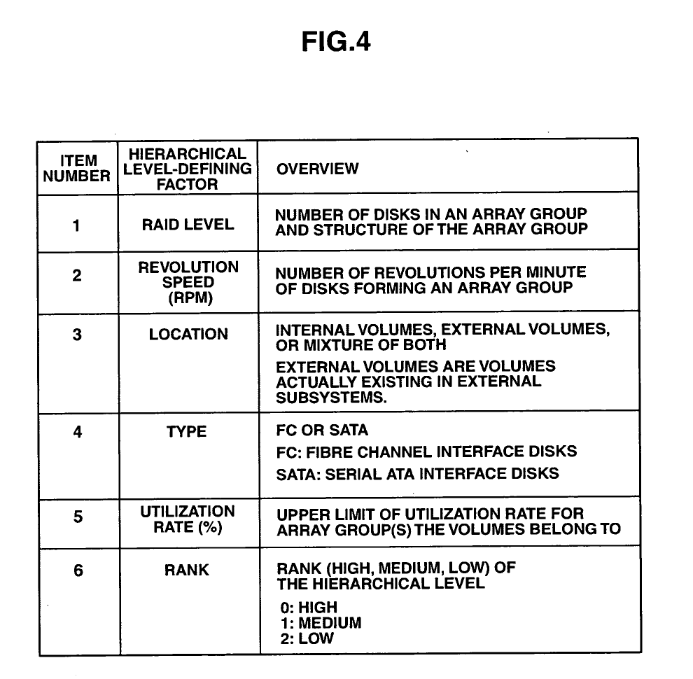

Some or all of the storage resources in the primary storage subsystem 1500 are arranged in a hierachy. In the example in FIG. 2, the primary storage subsystem 1500 has the hierarchical levels 1510, 1520 and 1530. Likewise, the standby storage subsystem 1600 has hierarchical levels 1610, 1620 and 1630. The hierarchical level 1510 is associated with the hierarchical level 1610; the hierarchical level 1520 is associated with the hierarchical level 1620; and the hierarchical level 1530 is associated with the hierarchical level 1630. In this invention, a hierarchy is an idea for classifying array groups. On one hierarchical level, one or more array groups can exist. The performance and features of an array group are defined by the performance and features of the memory devices (e.g., HDDs) constituting that array group, and the utilization rate of the memory devices by the host. Predetermined array groups are assigned to each hierarchical level according to their performance and features. Details will be explained later with reference to FIG. 4.

The reference numeral 2000 indicates a switch for a management system 2002 to access the primary and standby storage subsystems via a network. When performing remote copy, the volume 1710 is a copy source volume and the volume 1810 is a copy destination volume.

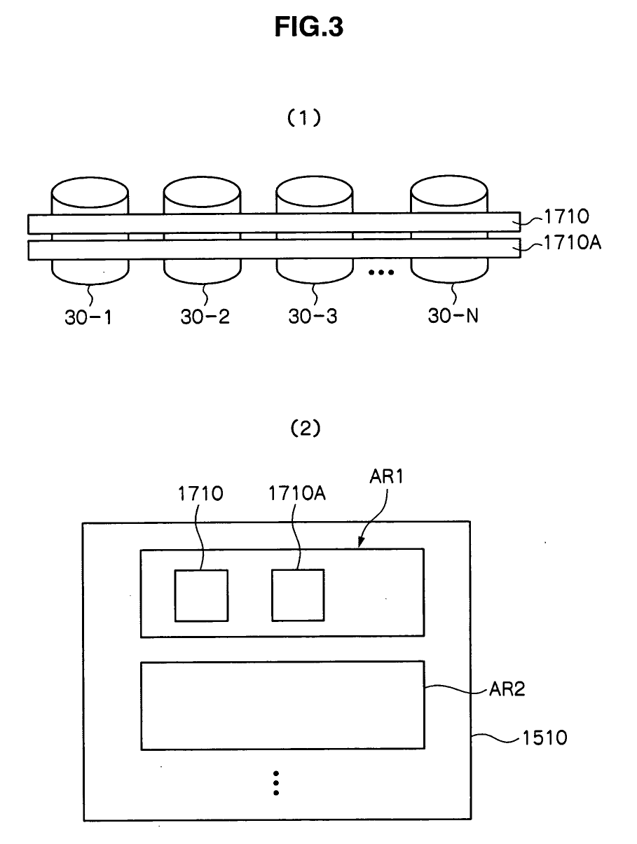

FIG. 3(1) shows the situation where a plurality of volumes 1710 and 1710A are formed from the memory devices (30-1, 30-2, . . . and 30-N) constituting one array group. As shown in FIG. 3(2), a plurality of array groups (e.g., AR1 and AR2) exist on the hierarchical level 1510 and each array group includes one or more volumes (e.g., AR1 has volumes 1710 and 1710A).

FIG. 4 is a table showing factors for defining a hierarchical level in a storage subsystem. ‘RAID level’ is the number of disks in an array group and the structure of the disks. ‘Revolution speed’ is the revolution speed of the disks constituting the array group. ‘Location’ specifies whether the volumes on the hierarchical level are volumes inside the storage subsystem, or volumes in another storage subsystem connected to the storage subsystem, or volumes in both storage subsystems. ‘Type’ specifies the type of the interface for the disks constituting the array group(s)—whether the interface is Fibre Channel or SATA. ‘Utilization rate’ is the upper limit of the utilization rate of the array group(s) the volumes belong to. ‘Rank’ specifies the rank of the hierarchical level: 0=high, 1=medium, 2=low.

Each hierarchical level is defined by the content of one or more of the elements shown in FIG. 4. As already mentioned, a hierarchy is an idea for grouping volumes based on their reliability, performance and costs. A plurality of hierarchical levels is formed in each storage subsystem. In the storage system in FIG. 2, storage areas are formed on three hierarchical levels in the respective primary and standby storage subsystems. Once a volume is set on a hierarchical level, it has performance that fulfills the specifications defined for that hierarchical level. A storage system manager defines hierarchical levels and determines which volumes—including copy source volumes and copy destination volumes—should be set on which hierarchical levels. The manager makes settings for the hierarchical levels and volumes for the management system 2002 and the storage subsystems via a management client connected to the management system 2002. The hierarchical levels and volumes are managed by various management programs in the management system 2002, which will be described later.

The respective hierarchical levels are ranked according to their volume performance. In the storage subsystem 1500 in FIG. 2, the volume performance of the hierarchical level 1510 is higher than that of the hierarchical level 1520; and the volume performance of the hierarchical level 1520 is higher than that of the hierarchical level 1530. Likewise, in the storage subsystem 1600, the volume performance of hierarchical level 1610 is higher than that of the hierarchical level 1620; and the performance level of the hierarchical level 1620 is higher than that of the hierarchical level 1630. The higher the volume performance of a hierarchical level is, the higher the hierarchical level is ranked. In the storage system in FIG. 2, the hierarchical levels in the storage subsystem 1500 are respectively associated with those with the same rank in the storage subsystem 1600. One aspect of good volume performance is that the memory devices constituting a volume have good response to access from the host.

Factors defining the hierarchical levels in the storage subsystem 1500 and those defining the hierarchical levels in the storage subsystem 1600 may be the same or different. FIG. 5 shows an example of definition of the hierarchical structure in the primary storage subsystem and that in the standby storage subsystem.

The hierarchical levels are defined based on their RAID levels, revolution speeds, volume locations, and types of memory devices. The array groups constituting the hierarchical levels are each formed with memory devices fulfilling the specifications that define the hierarchical levels. A typical example of a memory device is a hard disk drive, but it may also be semiconductor memory such as flash memory. According to FIG. 5, the hierarchical level 1-1 has a higher volume performance than that of the hierarchical level 1-2. Likewise, the hierarchical level 2-1 has a higher volume performance than that of the hierarchical level 2-2.

In FIG. 2, the copy source volume 1710 belongs to the highest hierarchical level 1510 in the primary storage subsystem 1500, and the copy destination volume 1810 belongs to the highest hierarchical level 1610 in the standby storage subsystem 1600. Because the copy destination volume 1810 is set on the hierarchical level associated with the hierarchical level of the copy source volume 1710, even when access from the host during failover is directed from the copy source volume 1710 to the copy destination volume 1810, degradation of the access performance of the storage system can be prevented.

To set a volume on a hierarchical level involves forming a volume in an array group fulfilling the specifications defining that hierarchical level. The copy destination volume may alternatively be set on a hierarchical level higher than the one associated with the hierarchical level of the copy source volume. Which hierarchical level the copy destination volume is set on in relation to the hierarchical level of the copy source volume determines the relationship between the hierarchical level of the copy source volume and that of the copy destination volume.

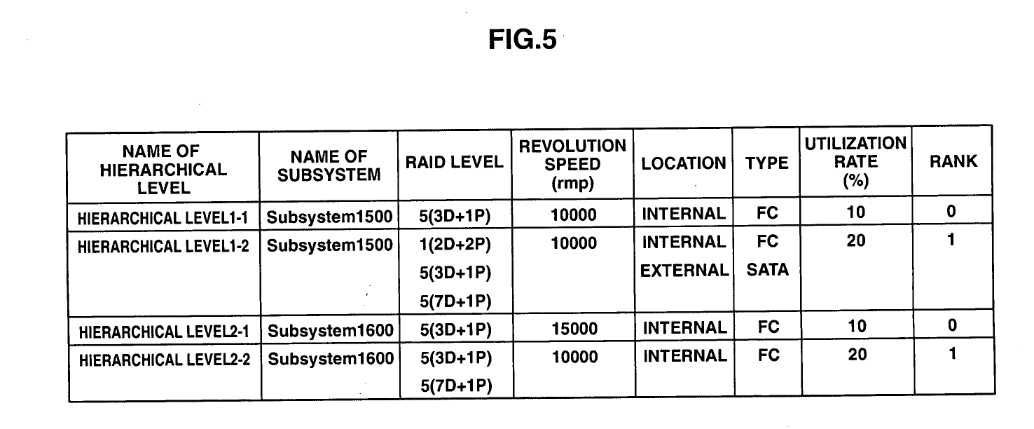

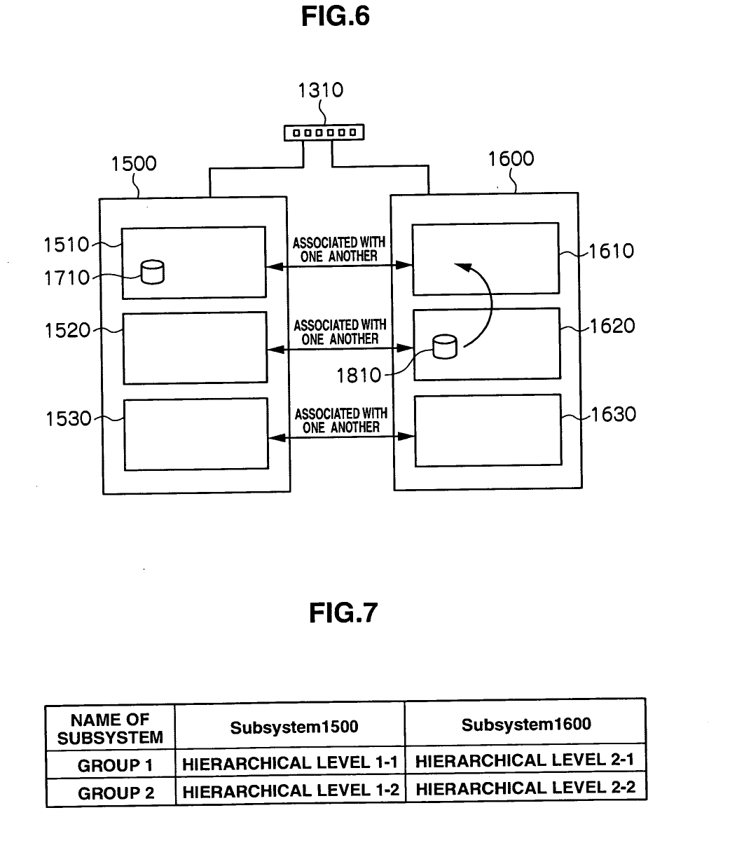

Which hierarchical level in the primary storage subsystem the copy source volume is set on is determined as appropriate by the manager, taking into consideration the access performance from the host to the primary subsystem. There are some cases where the existing correspondence relationship between the hierarchical level of the primary copy source volume and that of the standby copy destination volume is not identical to their original correspondence relationship. For example, in FIG. 6 where the volume 1710 is the copy source volume and the volume 1810 is the copy destination volume, although the hierarchical level 1510 of the copy source volume 1710 is associated with the hierarchical level 1610, the copy destination volume 1810 is actually set on the hierarchical level 1620, not on the level 1610.

For operational reasons, it is conceivable that the copy destination volume 1810 is located on the hierarchical level 1620, not on the level 1610, in spite of the fact that the primary copy source volume 1710 exists on the hierarchical level 1510 if a different volume in the hierarchical level 1610 is engaged in services for the host, but the degradation of the performance of the hierarchical level 1610 is undesirable.

However, when performing failover in this state, the access performance from the host to the copy destination volume 1810 may be lower than that from the host to the copy source volume 1710. However, if the volume 1810 on the hierarchical level 1620 in the standby storage subsystem 1600 is migrated to the hierarchical level 1610, the access performance from the host to the volume 1810 can be maintained because its performance is upgraded.

As a result of migrating the volume 1810 to the hierarchical level 1610, the utilization rate of the array group on the hierarchical level 1610 increases. The access performance from the host to a volume—an access destination—depends on the performance defined for the hierarchical level as well as the rate of utilization of the array group the volume belongs to by the host. When the host accesses both the volume 1810 on the hierarchical level 1610 and another volume in the same array group on the same hierarchical level 1610, the accesses to the volumes compete with one another within the same array group and the access performance from the host to the copy destination volume 1810 degrades.

A utilization rate (%) is calculated using the following formula [I]. [Formula I] A utilization rate (%)=Total amount of transfer data (MB/sec)/Average transfer speed (MB/sec)+Total number of requests (requests/sec)×Average interval between request processing (sec/request) With the formula 1, the amount of data transferred per minute and the time required in post-processing are calculated. The total number of requests is the number of requests for writing and reading the host makes to an array group per second. The average interval between request processing is the time required for a memory device to accept the next request after completing the previous request from the host. The total amount of transfer data is the amount of data the host transfers to a storage subsystem per second. The average transfer speed is the average data transfer speed of memory devices constituting an array group. The average interval between request processing and the average transfer speed are determined depending on the performance of the disks constituting the array group.

There are some cases where, when a copy destination volume is migrated from its current hierarchical level to a higher level, the rate of utilization of the memory devices constituting the array group on the migration destination hierarchical level exceeds an upper limit, which is previously set for that migration destination hierarchical level. In order to prevent this, the copy destination volume may not be migrated or a different volume belonging to the migration destination hierarchical level may be migrated to another hierarchical level.

FIG. 7 is a control table showing an example of correspondence relationships between the hierarchical levels in the primary storage subsystem 1500 and those in the standby storage subsystem 1600. This control table shows that the hierarchical level 1-1 in the storage subsystem 1500 is associated with the hierarchical level 2-1 in the storage subsystem 1600 and the hierarchical level 1-2 in the storage subsystem 1500 is associated with the hierarchical level 2-2 in the storage subsystem 1600

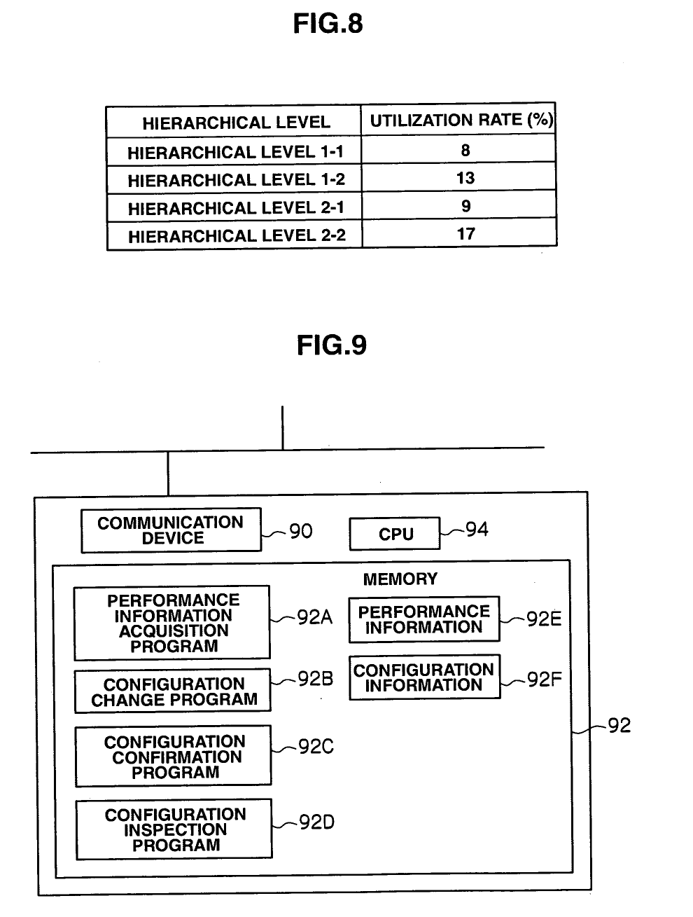

FIG. 8 is a table showing an example of utilization rates of the hierarchical levels. The management system always monitors the status of access from the host to the volumes belonging to the respective hierarchical levels and calculates their utilization rates based on the foregoing formula [I]. If a copy destination volume is migrated from the hierarchical level 2-2 in the storage subsystem 1600 to the hierarchical level 2-1, the utilization of the hierarchical level 2-2 decreases while that of the hierarchical level 2-1 increases. The management system calculates the changes in the utilization rates and judges whether the utilization rate of the hierarchical level 2-1 exceeds an upper limit.

FIG. 9 is a hardware block showing the management system. This management system is composed of: a communication device 90 that communicates with the primary and standby storage subsystems; memory 92 that stores programs and data; and a CPU 94 that controls the entire management system.

The memory 92 stores: a performance information acquisition program 92A; configuration change program 92B; configuration confirmation program 92C; configuration inspection program 92D; performance information 92E; and configuration information 92F. The CPU 94 executes the performance information acquisition program 92A to obtain the performance information for the primary and standby storage subsystems.

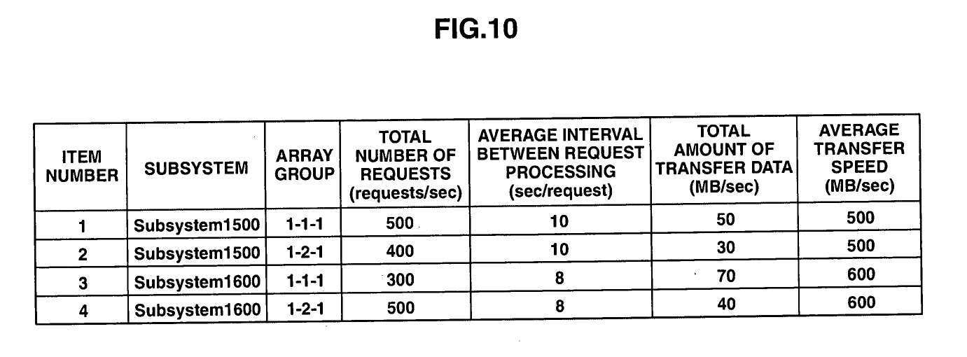

FIG. 10 is a table for storing performance information. The CPU 94 executes the performance information acquisition program 92A to obtain the performance information from the storage subsystems. The memory 92 stores this performance information in a storage area in a table format. This performance information table stores, for each array group in the storage subsystems, the total number of requests, the average interval between request processing, the total amount of transfer data, and the average transfer speed. The CPU 94 monitors the access statuses of the storage subsystems from the host and calculates their total number of requests and total amount of transfer data. Average intervals between request processing and average transfer speeds relate to the performances of the memory devices. The CPU 94 obtains this performance information from the storage subsystems via the communication device 90.

The CPU 94 executes the configuration confirmation program 92B to check whether the cluster systems composed of the primary and standby storage subsystems are engaged in failover. If the primary storage subsystem goes down, the configuration confirmation program 92C detects this situation and calls the configuration change program 92B. Using this configuration change program 92B, the CPU 94 checks the correspondence relationship between the hierarchical level of the copy source volume and that of the copy destination volume.

If the copy destination volume is not on the hierarchical level specified for itself in the table showing the correspondence relationships between the hierarchical levels, it is migrated to that level. The primary host executes a cluster management program, detects trouble in the primary storage subsystem, and entrusts the standby host with its operations. The standby host accesses the copy destination volume in the standby storage subsystem. Examples of trouble in the primary-side the storage system include trouble in the primary host; trouble in the primary storage subsystem; and trouble in both primary host and primary storage subsystem. If the primary host has a problem, the standby host takes over the primary host's processing and data and the standby storage subsystem takes over the primary storage subsystem's processing and data.

The same steps are performed when a problem occurs in the primary storage subsystem. The management system always monitors the operational status of the primary storage subsystem and when the primary storage subsystem is succeeded by the standby storage subsystem, it can know that failover is performed based on the operational status of the primary storage subsystem.

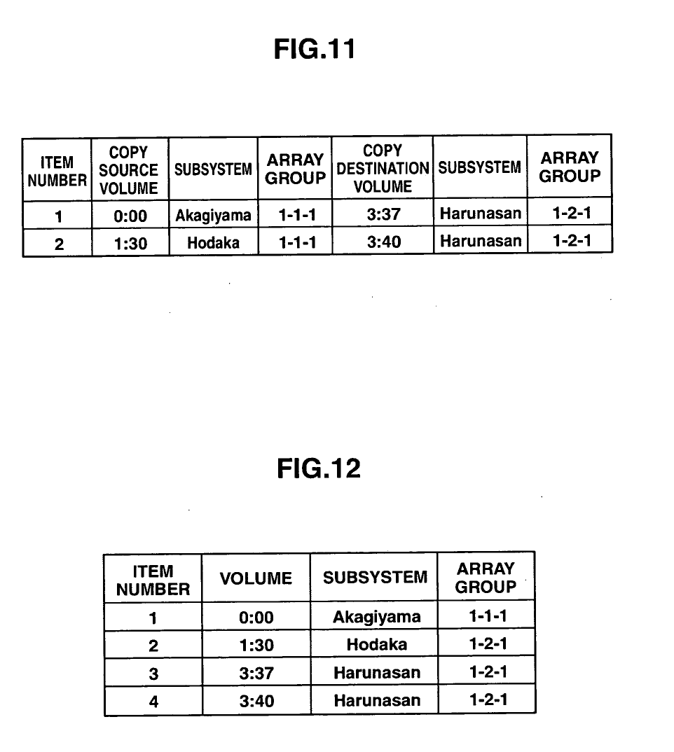

The configuration information 92F is composed of a remote copy management table, volume management table, hierarchical level management table, and hierarchical level correspondence table. FIG. 11 shows an example of the remote copy management table which shows that the copy source volume 0:00 belonging to the array group 1-1-1 in the subsystem Akagiyama is remote-copied to the copy destination volume 3:37 belonging to the array group 1-2-1 in the subsystem Harunasan. This remote copy management table manages the pairs of remote copy source volumes and remote copy destination volumes. With this table, paths are formed between the copy source volumes in the primary storage subsystem and the copy destination volumes in the standby storage subsystem.

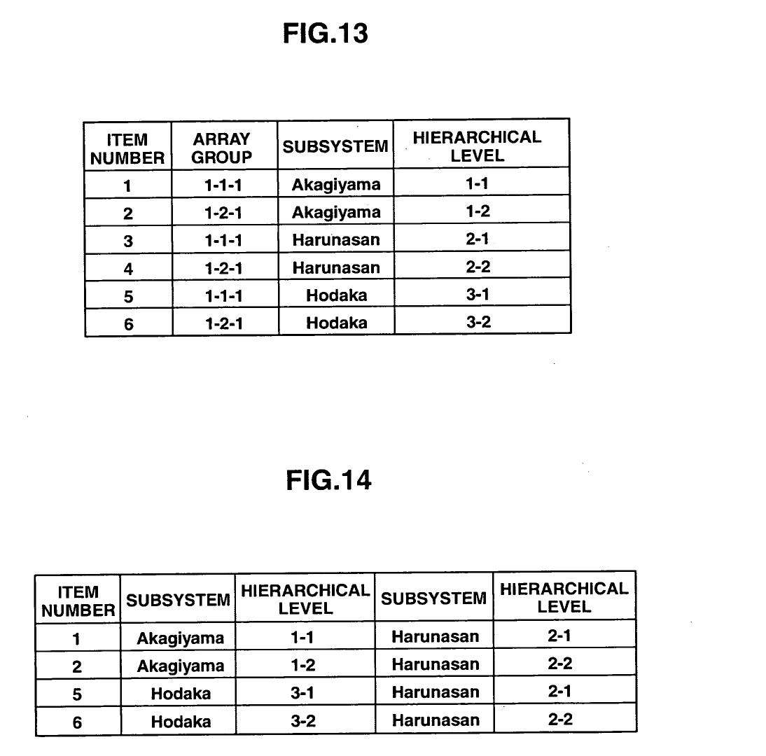

The volume management table shown in FIG. 12 shows relationships between volumes and the storage subsystems and array groups the volumes belong to. For example, the volume 0:00 belongs to the subsystem Akagiyama, and more precisely, to the array group 1-1-1 in that subsystem. The array group management table shown in FIG. 13 shows relationships between array groups, hierarchical levels, and storage subsystems. For example, it shows that the array group 1-1-1 constitutes the hierarchical level 1-1 in the subsystem Akagiyama. The hierarchical level management table manages hierarchical levels and their attribute values.

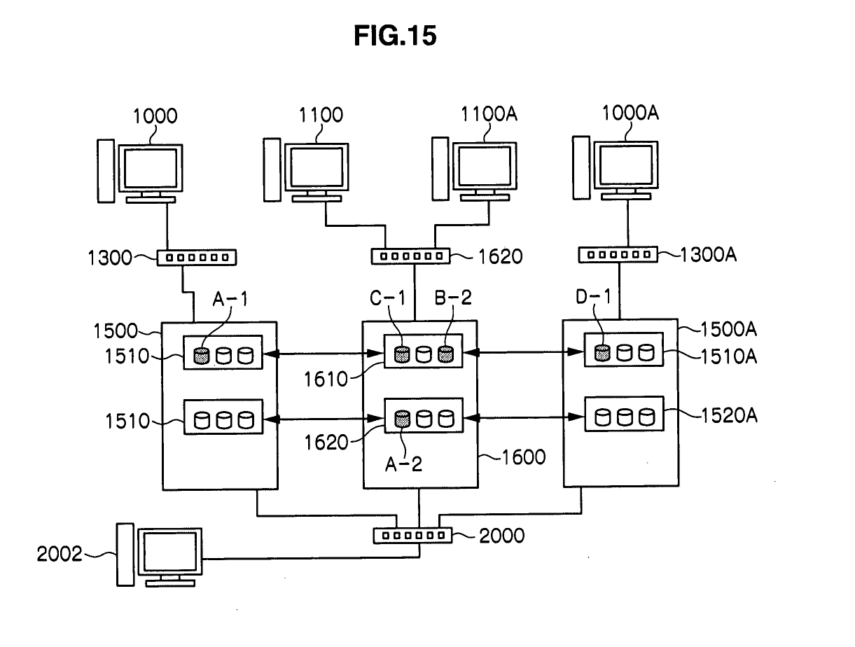

The aforementioned FIG. 5 shows the foregoing hierarchical level management table. The hierarchical level correspondence table manages correspondence relationships between the hierarchical levels in the primary storage subsystem and those in the standby storage subsystem. The aforementioned FIG. 7 shows this hierarchical level correspondence table. FIG. 14 shows another example of the hierarchical level correspondence table. According to the correspondence relationships between the hierarchical levels shown in FIG. 14, Akagiyama and Hodaka are primary storage subsystems, and Harunasan serves as the standby storage subsystem for both primary storage subsystems. The correspondence relationships between the hierarchical levels in the storage subsystems are as shown in FIG. 14. The hierarchy of the volumes in the storage subsystems is managed based on the management tables shown in FIGS. 11 to 14.

FIG. 15 is a block diagram showing a storage system where the hierarchical levels have the correspondence relationships shown in the management table in FIG. 14. In this storage system, a first primary system consisting of a host 1000 and storage subsystem 1500 is associated with a first standby system consisting of a host 1100 and storage subsystem 1600, and a second primary system consisting of a host 1000A and storage subsystem 1500A is associated with a second standby system consisting of a host 1100A and storage subsystem 1600. In other words, the storage system in FIG. 15 is composed of two cluster systems.

A copy source volume A-1 is remote-copied to a copy destination volume A-2 and a copy source volume B-1 is remote-copied to a copy destination volume B-2. Standby volumes A-2 and B2 exist in the same standby storage subsystem.

The hierarchical level 1510 in the first primary storage subsystem 1500 is associated with the hierarchical level 1610 in the standby storage subsystem 1600, and the hierarchical level 1510A in the second primary storage system 1500A is also associated with the hierarchical level 1610 in the standby storage subsystem 1600. The hierarchical level 1520 in the first primary storage subsystem 1500 is associated with the hierarchical level 1620 in the standby storage subsystem 1600, and the hierarchical level 1520A in the second primary storage system 1500A is associated with the hierarchical level 1620 in the standby storage subsystem 1600.

The copy source volume A-1 exists on the hierarchical level 1510 in the first primary storage subsystem 1500 and the copy source volume B-1 exists on the hierarchical level 1510A in the second primary storage subsystem 1500A. Before failover is performed, the copy destination volume A-2 exists on the hierarchical level 1620 in the standby storage subsystem 1600 and the copy destination volume B-2 exists in the hierarchical level 1610 in the same standby storage subsystem 1600. A volume C-1 is a volume defined originally on the hierarchical level 1610 in the standby storage subsystem 1600. The standby storage subsystem 1600 provides the hosts 1100 and 1100A with the storage areas of its original volume C-1, which is not a remote copy destination for any volume in the primary storage subsystems.

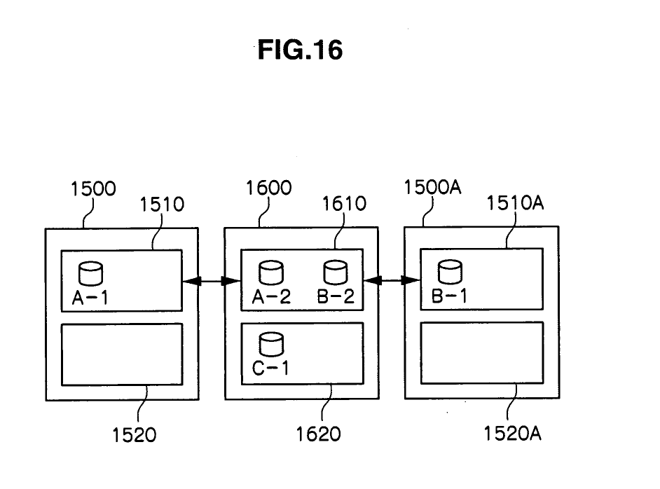

As shown in FIG. 16, when trouble occurs in the first primary storage subsystem 1500, the management system migrates the copy destination volume A-2 from the hierarchical level 1620 to the level 1610 so that the volume has better performance. Here, migration of the volume is actually carried out by migrating the data in the migration source volume to a volume on the migration destination hierarchical level. If the utilization of the migration destination hierarchical level exceeds the upper limit previously set for that hierarchical level due to the migration, a different volume on the destination hierarchical level is migrated to another hierarchical level. In FIG. 16, the volume C-1 is migrated from the hierarchical level 1610 to the lower level 1620.

Here, instead of migrating the volume C-1, the volume B-2 may be migrated to the lower hierarchical level or both C-1 and B-2 may be migrated to the lower hierarchical level. As shown in FIG. 16, if the ratio of the number of primary subsystems to the number of standby subsystems is n:1 (in the example of FIG. 17, n=2), the standby storage subsystem includes a plurality of copy destination volumes. If all the copy destination volumes are located on the hierarchical levels corresponding to the hierarchical levels of their copy source volumes, the performance of the hierarchical levels in the standby storage system degrades, so some copy source volumes may be located on non-corresponding hierarchical levels. In FIG. 16, before failover is performed, the copy destination volume A-2 is located on the hierarchical level 1620, which is not associated with the hierarchical level 1510.

FIG. 17 is a flowchart showing processing performed when the CPU in the management system executes the performance information acquisition program. When the management system starts the processing according to this flowchart, it judges whether there is any subsystem it has not obtained the performance information for(step S1700), and if it has already obtained the performance information for all of the subsystems, it terminates the processing shown in FIG. 17. Here, the storage subsystems include primary and standby storage subsystems.

If the judgment in step S1700 is positive, the management system selects one of the storage subsystems under its control (step S1702). For example, the management system refers to the remote copy management table in FIG. 11 to see the storage subsystems inside the storage system. Then, it obtains performance information for the memory devices constituting all the array groups in the selected storage subsystems (step S1704), and updates the performance information table shown in FIG. 10 (step S1706).

Then, the processing returns to step S1700. For each array group, its total number of requests and total amount of transfer data changes depending on the access status from the host to the array group. Based on this access status, the management system obtains the total number of requests and total amount of transfer data. Other information in the performance information table is unique values for the storage subsystems and memory devices. The management system executes the processing in FIG. 17 to obtain the latest performance information.

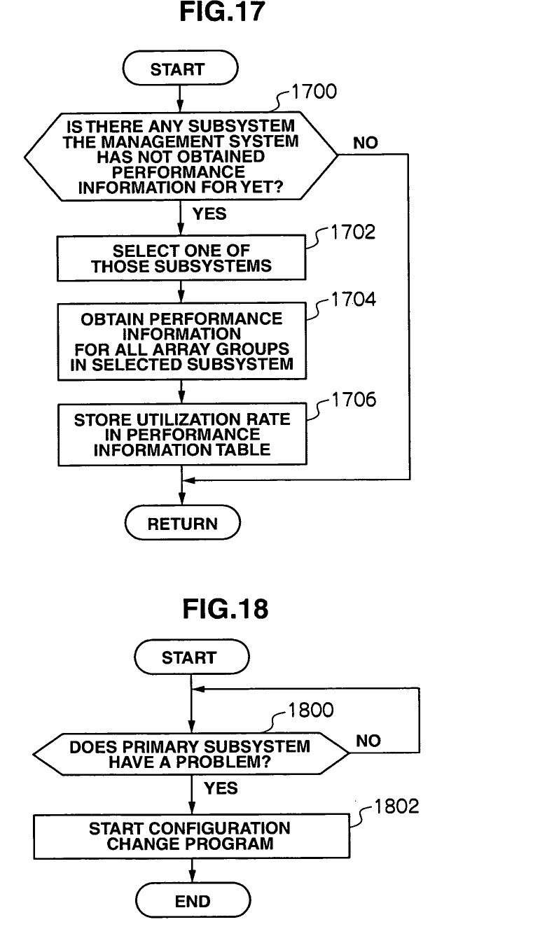

FIG. 18 shows the operation performed based on the foregoing configuration confirmation program. The management system always monitors whether a problem occurs in the primary storage system. The management system accesses the primary storage subsystem at regular intervals to check if it is alive and, if there is no response from the primary storage subsystem, it judges that the primary storage subsystem has a problem (step S1800) and starts the configuration change program (step S1802).

Then, the access from the primary host to the primary storage subsystem is switched to access from the standby host to the standby storage subsystem. When the primary storage subsystem recovers from the trouble, the processing in FIG. 18 is resumed.

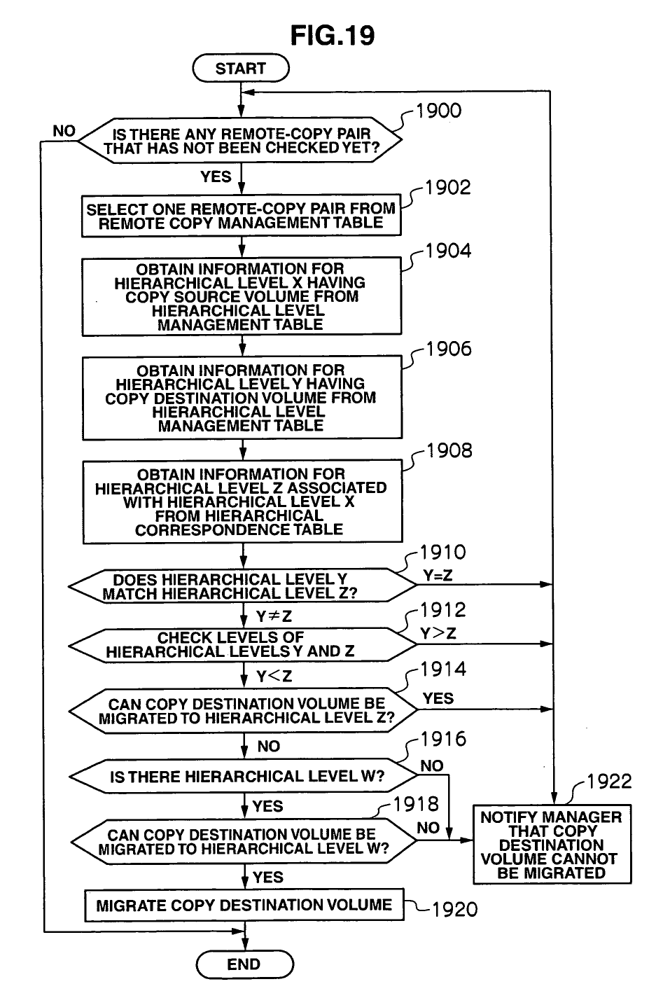

FIG. 19 shows the operation performed based on the configuration change program. This program is called by the configuration confirmation program when performing failover for the primary storage system. First, the management system refers to the remote copy management table and judges whether there are remote-copy pairs of copy source volumes and copy destination volumes i.e., check targets for the management system (step S1900). If the judgment is positive, it selects one of the remote-copy pairs from the remote copy management table (step S1902). Then, it obtains information for the hierarchical level X that has the copy source volume from the hierarchical level management table (step S1904), and then obtains information for the hierarchical level Y that has the copy destination volume from the same table (step S1906). Then, it also obtains information for the hierarchical level Z associated with the hierarchical level X from the hierarchical correspondence table (step S1908).

The management system then judges whether the hierarchical level Y matches the hierarchical level Z (step S1910) and, if the judgment is positive, it judges that there is no need to change the current hierarchical level of the copy destination volume, and returns to step S1900. Meanwhile, if the judgment is negative in step S1910, the management system checks the levels of the hierarchical levels Y and Z (step S1912) and, if the hierarchical level Y is higher than the hierarchical level Z, it judges that the current hierarchical level of the copy destination volume does not have to be changed, and returns to step S1900.

Meanwhile, if the hierarchical level Y is lower than the hierarchical level Z, the management system judges whether the copy destination volume can be migrated to the hierarchical level Z (step S1914). If the judgment is positive, the migration is started and the processing returns to step S1900. Meanwhile, if the judgment is negative, it judges whether there is a hierarchical level W which is higher than the hierarchical level Y and lower than the hierarchical level Z (step S1916). If the judgment is positive, it further judges whether the copy destination volume can be migrated to the hierarchical level W (step S1918). If the judgment is positive, the copy destination volume is migrated from the hierarchical level Y to the hierarchical level W (step S1920). If the judgment in steps S1916 and 1918 is negative, the management system notifies the manager (management client device) that the copy destination volume cannot be migrated from the hierarchical level Y to another hierarchical level (step S1922).

Incidentally, if there is more than one hierarchical level W, the management system judges, starting with the highest hierarchical level, whether the copy destination volume can be migrated there. If the copy destination volume cannot be migrated from the hierarchical level Y to any of the hierarchical levels W, the management system judges that migration of the copy destination volume is impossible. Incidentally, in step 1900, the management system judges whether all the remote-copy pairs have been checked and if the judgment is positive, the processing is terminated.

Migrating the copy destination volume from its current hierarchical level to another involves migrating the data in the copy destination volume to a volume in an array group on the destination hierarchical level. The correspondence relationships between the copy destination volume and the array group as well as the hierarchical level it belongs to can be clarified by referring to both the volume management table and the array group management table. The information in these management tables is updated with the information for the latest correspondence relationships when the copy destination volume is migrated from one hierarchical level to another using the program shown in FIG. 16.

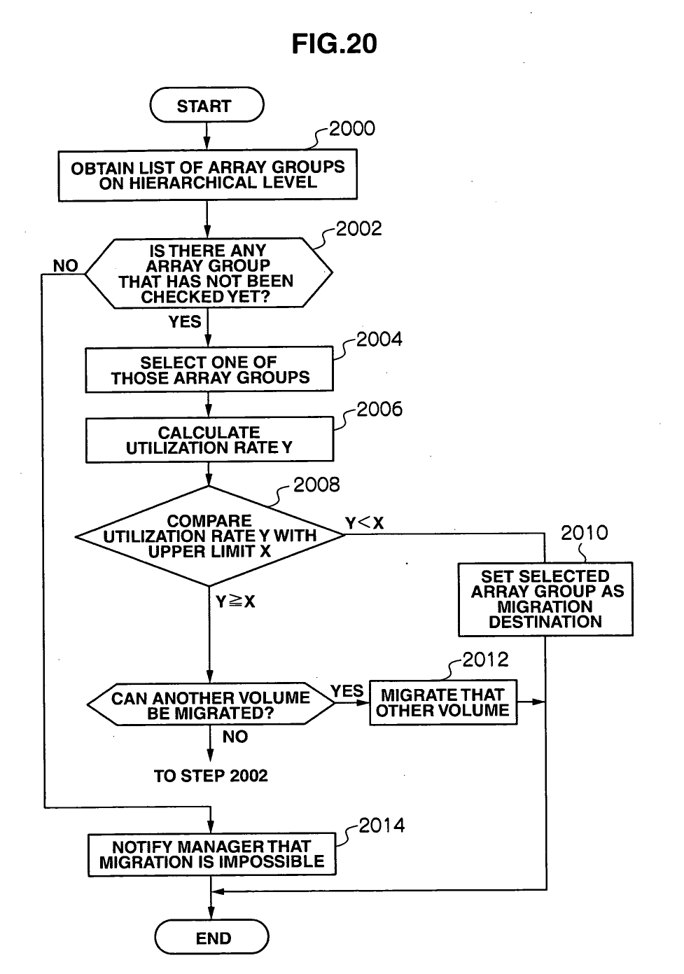

FIG. 20 shows a flowchart showing a routine for the management system to judge whether a copy destination volume can be migrated from one hierarchical level to another. The management system obtains from the array group management table a list of array groups on the hierarchical level the copy destination volume in the standby storage system should be migrated to (step S2000). The management system then judges whether there are array groups it has not checked yet (step S2002) and, if the judgment is positive, it proceeds to step S2004 where it selects one of these array groups. Then, it calculates the utilization rate (y) of the selected array group based on the foregoing formula [I] using the performance information table in FIG. 10 (step S2006).

The management system then compares this utilization rate (y) with the upper limit (x) set for the hierarchical level of the selected array group (step S2008) and if y is smaller than x (y<x), it judges that the copy destination volume can be migrated to the memory device forming the selected array group and carries out that migration. Consequently, the copy destination volume is migrated from the current hierarchical level to another (step S2010). Incidentally, the management system can find out that upper limit (x) by referring to the performance information table.

If y is equal to or is larger than x (y=x or y>x), the management system judges whether a different volume formed in the selected array group can be migrated to an array group on a different hierarchical level and if the judgment is positive, it migrates that volume from the array group on the current hierarchical level to a selected array group on the different hierarchical level (step S2012). If the judgment is negative, the management system notifies the manager that migration of the volume is impossible. The management system then returns to step S2002 where it judges whether it has checked all the array groups. If the judgment is positive, the processing is terminated.

Whether a different volume can be migrated to an array group on a different hierarchical level can be decided based on the utilization rate of its migration destination array group, using the same method as the foregoing method. If the volume cannot be migrated to a different hierarchical level, it means that the copy destination volume cannot be migrated to the target hierarchical level, so, the management system notifies the manger of that fact. Having been notified of that fact, the manger may take measures such as adding a memory device.

During the migration of the copy destination volume to another hierarchical level, write data from the host is temporarily stored in the cache memory in the standby storage subsystem and, when the migration is over, the data in the cache is written in the migration destination volume. Also, regarding reading of data from the copy destination volume by the host, if the migration of the copy destination volume is not complete, data is read from the copy destination volume on its original hierarchical level, but once the migration is complete, it is read from the post-migration copy destination volume on the destination hierarchical level.

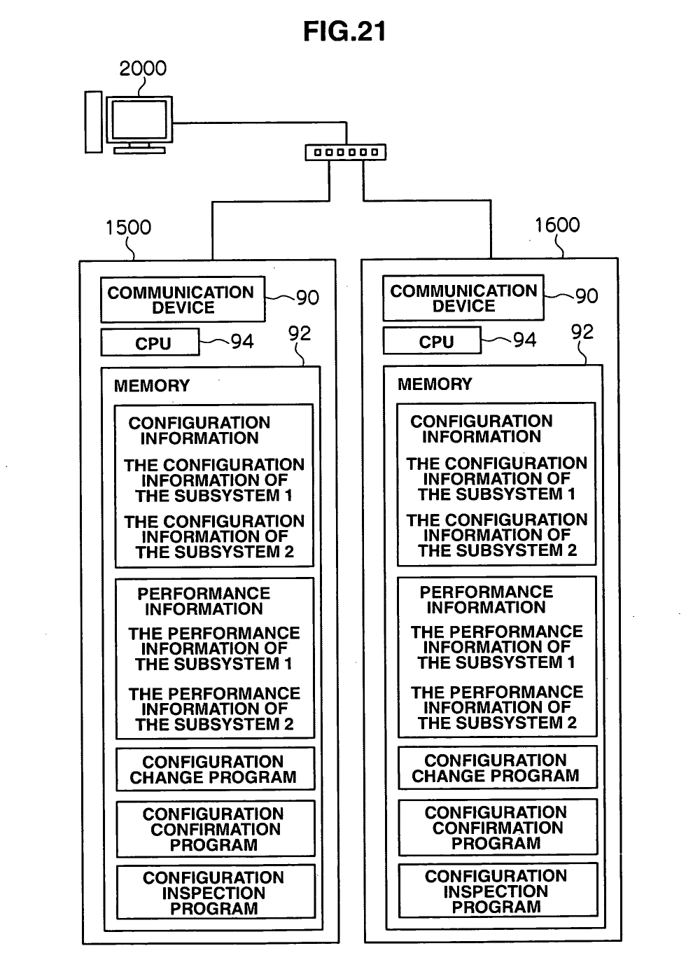

The foregoing embodiments were explained for the case where the management system manages the volumes in the storage subsystems, however, as shown in FIG. 21, it is also possible to have the controllers in the storage subsystems manage the volumes and hierarchical levels. FIG. 21 shows a storage system explaining that case.

In this example, each storage subsystem has a CPU 94, memory 92 and communication device 90. The storage subsystems share configuration information and performance information via a fibre cable connected thereto. In this case, the configuration change program and other programs, which are stored in the management system in the previous case, are stored in the memory in the storage subsystems. Confirmation of the configuration information and performance information in the storage subsystem is carried out by an external console 210. This console 210 is connected to the respective subsystems with a fibre cable, via which it obtains information from the subsystems.

The aforementioned embodiments are changeable, for example, the specifications defining the hierarchical levels and the number of the same can be changed as appropriate. Also, in addition to remote copy, this invention may also be applied to other recovery methods such as data backup performed between the storage subsystems or snapshot-based recovery performed in each storage subsystem. Moreover, in the example in FIG. 16, the volume C-1 is migrated from the hierarchical level 1610 to the lower hierarchical level 1620; however it may alternatively be migrated to a different array group on the hierarchical level 1610.

What is claimed is:

1. A storage system comprising:
a first storage subsystem and a second storage subsystem, each providing storage areas to a host system;
a first volume set for a storage area in the first storage subsystem;
a second volume set for a storage area in the second storage subsystem, the second volume being a replication destination volume for the first volume;
a first hierarchical structure wherein the storage areas in the first storage subsystem are divided into a plurality of hierarchical levels;
a second hierarchical structure wherein the storage areas in the second storage subsystem are divided into a plurality of hierarchical levels; and
a control unit having control information for associating the hierarchical levels belonging to the first hierarchical structure with the hierarchical levels belonging to the second hierarchical structure,
wherein, the control unit sets the first volume on a hierarchical level (A) from among the hierarchical levels in the first hierarchical structure, and it also sets the second volume on a hierarchical level (B) in the second hierarchical structure associated with the hierarchical level (A) in the first hierarchical structure.

2. The storage system according to claim 1, wherein the first storage subsystem and the second storage subsystem constitute a remote copy system, the first volume is a replication source volume, and the second volume is a replication destination volume.

3. The storage system according to claim 1,
wherein the first hierarchical structure is defined according to the performance of the memory devices constituting the storage areas in the first storage subsystem; and
the second hierarchical structure is defined according to the performance of the memory devices constituting the storage areas in the second storage subsystem.

4. The storage system according to claim 3, wherein the first and second hierarchical structures are each configured to have a plurality of hierarchical levels according to the superiority/inferiority of the performance of their memory devices and, according to this superiority or inferiority, the hierarchical levels in the second hierarchical structure are respectively associated with the hierarchical levels in the first hierarchical structure.

5. The storage system according to claim 4, wherein the control unit sets a hierarchical level in the second hierarchical structure higher than the hierarchical level in the same structure associated with the hierarchical level (A) in the first hierarchical structure, as the hierarchical level (B) and it sets the second volume on this hierarchical level (B).

6. The storage system according to claim 4, wherein the control unit sets the hierarchical level in the second hierarchical structure associated with the hierarchical level (A) in the first hierarchical structure, as the hierarchical level (B) and sets the second volume on that hierarchical level (B).

7. The storage system according to claim 1, wherein when the destination of access from the host system is switched from the first volume to the second volume, the control unit judges whether the second volume belongs to the hierarchical level (B) in the second hierarchical structure associated with the hierarchical level (A) of the first volume in the first hierarchical structure and, if the judgment is negative, it migrates the second volume to the hierarchical level (B) in the second hierarchical structure being associated with the hierarchical level (A) in the first hierarchical structure.

8. The storage subsystem according to claim 7, wherein the control unit calculates the rate of utilization of the second volume and that of the volumes belonging to the hierarchical level (B) in the second hierarchical structure and, if the total utilization rate exceeds an upper limit, the second volume is not migrated to the hierarchical level (B) in the second hierarchical structure.

9. The storage system according to claim 7, wherein the control unit calculates the utilization rate of the second volume and that of the volumes belonging to the hierarchical level (B) in the second hierarchical structure and, if the total utilization rate exceeds an upper limit, any one of the volumes in the hierarchical level (B) in the second hierarchical structure is migrated to another hierarchical level in the same structure.

10. The storage system according to claim 1, wherein before the destination of access from the host system is switched from the first volume to the second volume, the second volume is on a hierarchical level in the second hierarchical structure not associated with the hierarchical level (A) in the first hierarchical structure, and when the destination is switched from the first volume to the second volume, the control unit migrates the second volume to the hierarchical level (B) in the second hierarchical structure.

11. The storage system according to claim 1, further comprising:
a third storage subsystem providing storage areas to the host system;
a third volume set on a storage area in the third storage subsystem;
a fourth volume set on a storage area in the second storage subsystem, the fourth volume being a replication destination volume for the third volume; and
a third hierarchical structure wherein the storage areas in the third storage subsystem are divided into a plurality of hierarchical levels,
wherein, the control unit has control information for associating the hierarchical levels in the third hierarchical structure and those in the second hierarchical structure; sets the third volume on a hierarchical level (C) from among the hierarchical levels in the third hierarchical structure; and sets the fourth volume on a hierarchical level (D) in the second hierarchical structure, the hierarchical level (D) in the second hierarchical structure being associated with the hierarchical level (C) in the third hierarchical structure.

12. The storage system according to claim 11, wherein the hierarchical level (B) is the same as the hierarchical level (D) and, before failover where the destination of access from the host is switched from the first volume to the second volume, the control unit locates the second volume on a hierarchical level in the second hierarchical structure not associated with the hierarchical level (A) in the first hierarchical structure, but when failover is performed, the control unit migrates the second volume to the hierarchical level (B, D) in the second hierarchical structure.

13. The storage system according to claim 1, wherein the control unit is a management system connected to the first storage subsystem and the second storage subsystem.

14. The storage system according to claim 1, wherein the control unit is composed of a controller in the first storage subsystem and a controller in the second storage subsystem.

15. The storage system according to claim 1, wherein the second storage subsystem has a fourth volume in its hierarchical structure and this fourth volume is a copy destination volume for the copy source volume in the third storage subsystem.

16. The storage system according to claim 15, wherein before failover, where the destination of access from the host system is switched to the copy destination volume, the second and fourth volumes are formed on different hierarchical levels in the second hierarchical structure and when failover is performed, the controller sets the second volume and the third volume on the same hierarchical level in the second hierarchical structure.

17. A storage system comprising:
a first storage subsystem and a second storage subsystem, each providing storage areas to a host system;
a first volume set for a storage area in the first storage subsystem;
a second volume set for a storage area in the second storage subsystem, the second volume being a replication destination volume for the first volume;
a first hierarchical structure wherein the storage areas in the first storage subsystem are divided into a plurality of hierarchical levels;
a second hierarchical structure where the storage areas in the second storage subsystem are divided into a plurality of hierarchical levels; and
a control unit having control information for associating the hierarchical levels belonging to the first hierarchical structure with the hierarchical levels belonging to the second hierarchical structure,
wherein, the control unit sets the first volume on a hierarchical level (A) from among the hierarchical levels in the first hierarchical structure, and also sets the second volume on a hierarchical level (B) in the second hierarchical structure associated with the hierarchical level (A);
the first volume is a copy source volume and the second volume is a copy destination volume for the first volume;
the first hierarchical structure is defined according to the performance of the memory devices constituting the storage areas in the first storage subsystem;
the second hierarchical structure is defined according to the performance of the memory devices constituting the storage areas in the second storage subsystem;
the first and second hierarchical structures are each configured to have a plurality of hierarchical levels according to the superiority/inferiority of the performance of their memory devices and, according to this superiority or inferiority, the hierarchical levels in the second hierarchical structure are respectively associated with the hierarchical levels in the first hierarchical structure; and
when the destination of access from the host system is switched from the first volume to the second volume, the control unit judges whether the second volume belongs to the hierarchical level (B) in the second hierarchical structure associated with the hierarchical level (A) of the first volume in the first hierarchical structure and, if the judgment is negative, it migrates the second volume to the hierarchical level (B) in the second hierarchical structure associated with the hierarchical level (A) in the first hierarchical structure.

18. The storage system according to claim 1, wherein the hierarchical structure is defined according to the type of interface standard for the memory devices providing storage areas to the host system.

19. A method for managing volumes, utilized in a storage system, comprising:
setting a first volume in a first storage subsystem as a replication source volume;
setting a second volume in a second storage subsystem as a replication destination volume;
having the storage areas in the first storage subsystem form a first hierarchical structure consisting of a plurality of hierarchical levels;
having the storage areas in the second storage subsystem form a second hierarchical structure consisting of a plurality of hierarchical levels;
establishing correspondence relationships between the hierarchical levels in the first hierarchical structure and those in the second hierarchical structure;
setting the first volume on a hierarchical level in the first hierarchical structure;
setting the second volume on the corresponding hierarchical level in the second hierarchical structure, the corresponding hierarchical level in the second hierarchical structure being associated with the hierarchical level of the first volume in the first hierarchical structure; and
when the destination of access from a host system is switched from the first volume to the second volume, if the second volume exists on a hierarchical level other than the foregoing corresponding hierarchical level in the second hierarchical structure, migrating the second volume to that corresponding hierarchical level in the second hierarchical structure.
